(19) United States
(12) Patent Application Publication
(10) Pub. No.: US 2018/0268821 A1
(43) Pub. Date: Sep. 20, 2018

(54) VIRTUAL ASSISTANT FOR GENERATING PERSONAL SUGGESTIONS TO A USER BASED ON INTONATION ANALYSIS OF THE USER

(71) Applicant: BEYOND VERBAL COMMUNICATION LTD, Tel-Aviv (IL)

(72) Inventor: Yoram LEVANON, Ramat Hasharon (IL)

(21) Appl. No.: 15/982,032

(22) Filed: May 17, 2018

Related U.S. Application Data
(63) Continuation-in-part of application No. PCT/IL2016/051223, filed on Nov. 13, 2016.
(60) Provisional application No. 62/257,258, filed on Nov. 19, 2015.

(51) Int. Cl. G10L 15/26; G10L 15/22; G10L 25/66; G10L 25/63

(52) U.S. Cl. CPC G10L 15/265; G10L 25/63; G10L 25/66; G10L 15/22

(57) ABSTRACT

A method and system for generating one or more desired content and/or predictive task suggestions to a user based on voice tone analysis of the user, the method comprising: continuously receiving, in real-time, by a computing system comprising one or more computing devices, a voice input data indicative of speech from the user; analyzing, by the computing system, said voice input data, based on calculating of an average and maximum intensity functions across a plurality of frequencies; determining, by the computing system, from the voice input data, based at least in part upon a change in intensity between at least two frequencies found in the calculated maximum intensity function, predictive intention of the user with respect to the desired content and/or tasks associated with physiological and psychological states of the user, by an executable voice signal analysis module and a runtime verification comprising a model configured to at least one domain-specific content and/or task associated with physiological and psychological states of the user; and generating, by the computing system, content suggestion associated with the at least one domain-specific content and/or task associated with physiological and psychological states of the user.

### RELATED APPLICATIONS

This application is a Continuation-In-Part of PCT Patent Application No. PCT/IL2016/051223 having an International filing date of Nov. 13, 2016, which claims the benefit of priority of U.S. Provisional Application No. 62/257,258 filed on Nov. 19, 2015 entitled VIRTUAL ASSISTANT FOR GENERATING PERSONAL SUGGESTIONS TO A USER BASED ON INTONATION ANALYSIS OF THE USER. The contents of the above applications are all incorporated by reference as if fully set forth herein in their entirety.

### FIELD OF THE INVENTION

The present invention relates generally to a personal virtual assistant and, more particularly, to a personal virtual assistant that receives and analyzes voice intonation data of a user, determines physiological and psychological states of the user and generates suggestions relating improving the physiological and psychological states.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

A growing number of people are using a wide spectrum of truly personal computing devices, such as mobile devices to interact with them by performing a variety of functionality. In many instances, the users may interact with their devices through a virtual assistant. Virtual assistants thus act as an effective interface that allows users to seek information they desire.

As users engage computing devices for an ever growing diversity of functions, there has been a growing need to improve the way users interact with the devices. Being able to simply speak commands to a computing device was once impressive; today, this is commonplace and expected. Where users were once satisfied with one word commands or simple phrases, users are demanding better experiences with smarter devices that understand more and being more proactive, learning the user and interacting with the user only when needed

Virtual assistants with voice interfaces are known. U.S. Pat. No. 5,653,789 to Miner, et al. discloses a method implemented by a computer-based electronic assistant to receive and manage incoming calls to a subscriber. The electronic assistant in Miner, however, does not disclose a virtual assistant whose underlying behavior can be changed by the user or who has any degree of automatic adaptivity.

Voice response systems (VRS) that automatically adapt to the user are known. For example, U.S. Pat. No. 5,483,608 to O'Sullivan discloses an interactive VRS that automatically adapts to suit the speed at which the caller interacts with the system. The VRS disclosed in O'Sullivan is programmed to measure the response times of the caller and adjust the playing speed of the application dialogue's voice messages accordingly using an algorithm incorporated into the application software of the voice response system. Thus, if the caller is responding relatively fast and without error to the voice message prompts, the system will gradually speed up subsequent voice message prompts. If the caller is responding more slowly to the voice message prompts or is making errors in their responses, the system will slow down subsequent voice message prompts. The system disclosed in O'Sullivan, however, does not perform the actions of a virtual assistant, nor does it permit the user to control how the system adapts. The system is not related to analyzing physiological and psychological states of a user.

Personal virtual assistant for providing suggestions to a user has been previously described, based on a remote station carried by a user and an electronic medical device. One example is disclosed in U.S. Pat. No. 8,170,609, by Qualcomm Incorporated, Personal virtual assistant providing advice to a user regarding physiological information received about the user, disclosing a personal virtual assistant. The personal virtual assistant includes a medical device and remote station that is connectable via a wireless network to a server containing a control processor and rules engine. The medical device is used to provide physiological information to the remote station. The remote station communicates the physiological information and other related information to the server that monitors the information for a number of reasons, including determining whether the physiological information has a trend. Based on the detrimental trend, the server communicates back to the remote station virtual assistance in the form of advice regarding tips to help facilitate halting or reversing the trend. The invention however incorporates a use of an external remote station carried by a user and a dedicated electronic medical device. It does not utilize the existing in a mobile devices tone-related and sensor-based technology nor does transform the personal assistant in a proactive application rather than just informative.

Other examples employing a virtual healthcare assistant include U.S. Pat. App. No. 20140337048 to Next It Corporation, Conversational Virtual Healthcare Assistant, relate to a conversation user interface that enables patients to better understand their healthcare by integrating diagnosis, treatment, medication management, and payment, through a system that uses a virtual assistant to engage in conversation with the patient. The conversation user interface conveys a visual representation of a conversation between the virtual assistant and the patient. An identity of the patient, including preferences and medical records, is maintained throughout all interactions so that each aspect of this integrated system has access to the same information. The conversation user interface presents allows the patient to interact with the virtual assistant using natural language commands to receive information and complete task related to his or her healthcare. The virtual healthcare assistant herein, however, does not disclose a virtual assistant whose underlying behavior can be changed by the user or who has any degree of automatic proactive adaptivity.

U.S. Pat. App. No. 20110082711 to Masimo Laboratories, Inc, Personal digital assistant or organizer for monitoring glucose levels, relate to a personal health organizer that enables patients and healthcare personnel to manage health data. The personal health organizer can be a portable device adapted to receive physiological reading data from a health data collection device or derive reading data from signals acquired by a sensor, or a software module/platform for performing same that is configured to be executed on a general purpose computing device such as a mobile phone/computer. The personal health organizer integrates reading data with applications that assist and promote health management, including reminders, alerts and health data tracking. The reading data obtained can be forwarded to healthcare providers so they can provide feedback such as alerts and diagnoses to the user. The personal health organizer can also support electronic medical record integration via networked computing so that locally stored medical data are automatically synchronized with remotely stored medical data records. The system however does not utilize personal preferences of a user using the existing in a mobile devices tone-related and sensor-based technology nor does transform the personal assistant in a proactive helpful application.

Accordingly, there is a continuing need for better ways to facilitate user interaction with a computing device, to emulate a truly human assistant particularly in the mobile technology where keyboard-based input is limited and voice interaction is increasing in popularity.

Systems for indicating emotional attitudes through intonation analysis are known. U.S. Pat. No. 8,078,470 to Exaudios Technologies Ltd., System for indicating emotional attitudes through intonation analysis and methods thereof, discloses means and method for indicating emotional attitudes of a speaker, either human or animal, according to voice intonation. The invention also discloses a method for advertising, marketing, educating, or lie detecting by indicating emotional attitudes of a speaker and a method of providing remote service by a group comprising at least one observer to at least one speaker. The invention also discloses a system for indicating emotional attitudes of a speaker comprising a glossary of intonations relating intonations to emotions attitudes. The system however does not relate to physiological and psychological states' intonation analysis.

U.S. Pat. No. 7,398,213, to Exaudios Technologies, Method and system for diagnosing pathological phenomenon using a voice signal, relates to a method and system for diagnosing pathological phenomenon using a voice signal. In one embodiment, the existence of at least one pathological phenomena is determined based at least in part upon a calculated average and maximum intensity functions associated with speech from the patient. In another embodiment, the existence of at least one pathological phenomena is determined based at least in part upon the a calculated maximum intensity function associated with speech from the patient. The system does not utilize pathological phenomenon analysis into a form of virtual assistant generating personal preferences of a user using the existing in a mobile devices tone-related and sensor-based technology nor does transform the personal assistant in a proactive helpful application.

None of the current technologies and prior art, taken alone or in combination, does not address nor provide a solution for a personal virtual assistant that receives and analyzes voice tone metadata of a user, determines physiological and psychological states of the user and generates suggestions relating improving the physiological and psychological states, using the existing in a mobile devices tone-related and sensor-based technology. Referring to virtual assistant capabilities on mobile devices, the known technologies in prior art do not refer to the level of proactive accuracy of personal suggestions that should be presented, do not take into account considerations of improvement in physiological and psychological quality in terms of personal characteristics of each user, and as a result none of the existing personal assistants claimed have truly sufficient and human-like performance equivalent to the virtual personal assistant functionality described in the present invention.

Therefore, there is a long felt and unmet need for a system and method that overcomes the problems associated with the prior art.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

It is thus an object of the present invention to provide a method, using a computer processing system, for generating one or more desired content and/or predictive task suggestions to a user based on voice tone analysis of the user, the method comprising: continuously receiving, in real-time, by a computing system comprising one or more computing devices, a voice input data indicative of speech from the user; analyzing, by the computing system, said voice input data, based on calculating of an average and maximum intensity functions across a plurality of frequencies; determining, by the computing system, from the voice input data, based at least in part upon a change in intensity between at least two frequencies found in the calculated maximum intensity function, predictive intention of the user with respect to the desired content and/or tasks associated with physiological and psychological states of the user, by an executable voice signal analysis module and a runtime verification comprising a model configured to at least one domain-specific content and/or task associated with physiological and psychological states of the user; and generating, by the computing system, content suggestion associated with the at least one domain-specific content and/or task associated with physiological and psychological states of the user.

It is another object of the present invention to provide a method, using a computer processing system, for sharing one or more desired content and/or predictive task suggestions to a user based on voice tone analysis of the user between two or more users, the method comprising: prompting, automatically, an access by at least first user to a profile of at least second user, said second user profile based on the content suggested for at least one domain-specific content and/or task associated with physiological and psychological states of said second user based on the second user voice input data, based at least in part upon a change in intensity between at least two frequencies found in the calculated maximum intensity function; if access granted to the at least one first user by the at least one second user, sharing said second user profile with said at least one first user; generating, by the computing system, content suggestion for the at least one first user associated with the at least one domain-specific content and/or task associated with physiological and psychological states of the second user to improve said physiological and psychological states of the second user.

It is another object of the present invention to provide a virtual personal assistant platform for generating personal suggestions to a user based on intonation analysis of the user embodied in one or more non-transitory computer-readable media, the virtual personal assistant platform configured to cause a computing system comprising one or more computing devices to: continuously receive, in real-time, by a computing system comprising one or more computing devices, a voice input data indicative of speech from the user; analyze, by the computing system, said voice input data, based on calculating of an average and maximum intensity functions across a plurality of frequencies; determine, by the computing system, from the voice input data, based at least in part upon a change in intensity between at least two frequencies found in the calculated maximum intensity function, predictive intention of the user with respect to the desired content and/or tasks associated with physiological and psychological states of the user, by an executable voice signal analysis module and a runtime verification comprising a model configured to at least one domain-specific content and/or task associated with physiological and psychological states of the user; and generate, by the computing system, content suggestion associated with the at least one domain-specific content and/or task associated with physiological and psychological states of the user.

It is another object of the present invention to provide a virtual personal assistant platform for sharing one or more desired content and/or predictive task suggestions to a user based on voice tone analysis of the user between two or more users embodied in one or more non-transitory computer-readable media, the virtual personal assistant platform configured to cause a computing system comprising one or more computing devices to: prompt, automatically, an access by at least first user to a profile of at least second user, said second user profile based on the content suggested for at least one domain-specific content and/or task associated with physiological and psychological states of said second user based on the second user voice input data, based at least in part upon a change in intensity between at least two frequencies found in the calculated maximum intensity function; if an access granted to the at least one first user by the at least one second user, share said second user profile with said at least one first user; generate, by the computing system, content suggestion for the at least one first user associated with the at least one domain-specific content and/or task associated with physiological and psychological states of the second user to improve said physiological and psychological states of the second user.

It is another object of the present invention to provide method, using a computer processing system, for establishing a network of virtual personal assistant applications communicating one with another regarding one or more desired content and/or predictive task suggestions to a user based on voice tone analysis of the user between two or more users, the method comprising: providing at least one first virtual personal assistant platform for sharing one or more desired content and/or predictive task suggestions to a first user based on voice tone analysis of the user embodied in one or more non-transitory computer-readable media; providing at least one second virtual personal assistant platform for sharing one or more desired content and/or predictive task suggestions to a second user based on voice tone analysis of the user embodied in one or more non-transitory computer-readable media; said at least one first virtual personal assistant platform and at least one second virtual personal assistant platform are configured to communicate one or more desired content and/or predictive task suggestions associated with the users based on voice tone analysis of the users between two or more users embodied in one or more non-transitory computer-readable media to each other; said at least one first virtual personal assistant platform and at least one second virtual personal assistant platform are configured to establish content and/or predictive task suggestions communication network.

### BRIEF DESCRIPTION OF THE PREFERRED EMBODIMENTS

The novel features believed to be characteristics of the invention are set forth in the appended claims. The invention itself, however, as well as the preferred mode of use, further objects and advantages thereof, will best be understood by reference to the following detailed description of illustrative embodiment when read in conjunction with the accompanying drawings, wherein:

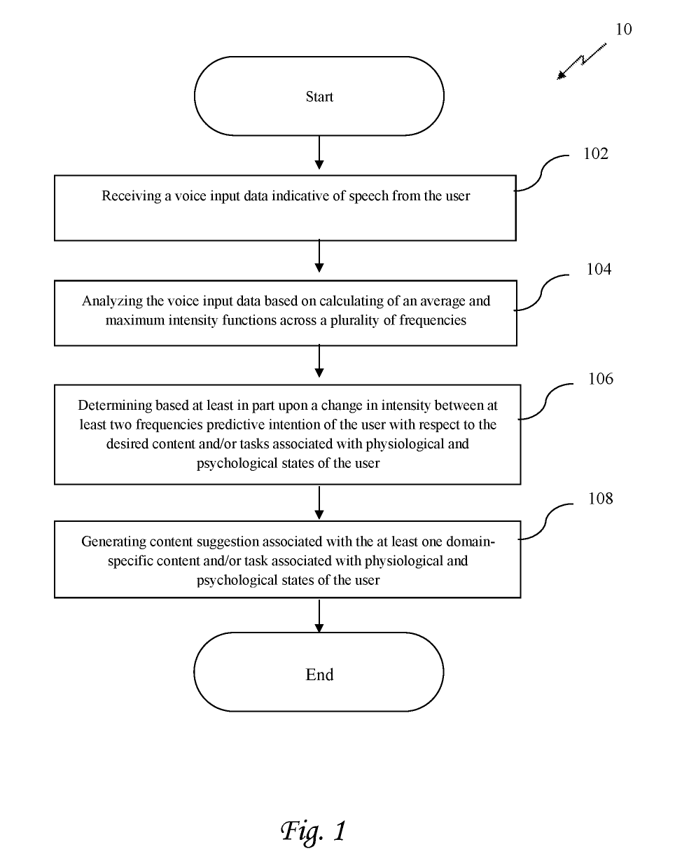

FIG. 1 presents a flow diagram method disclosed by the present invention;

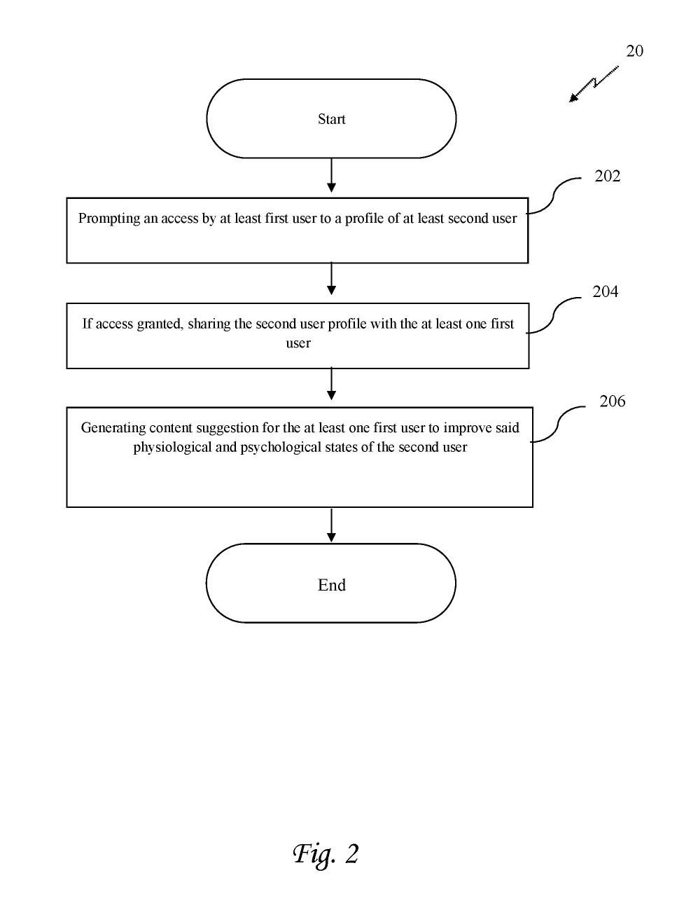

FIG. 2 presents a flow diagram method for sharing one or more desired content and/or predictive task suggestions to a user based on voice tone analysis of the user between two or more users disclosed by the present invention;

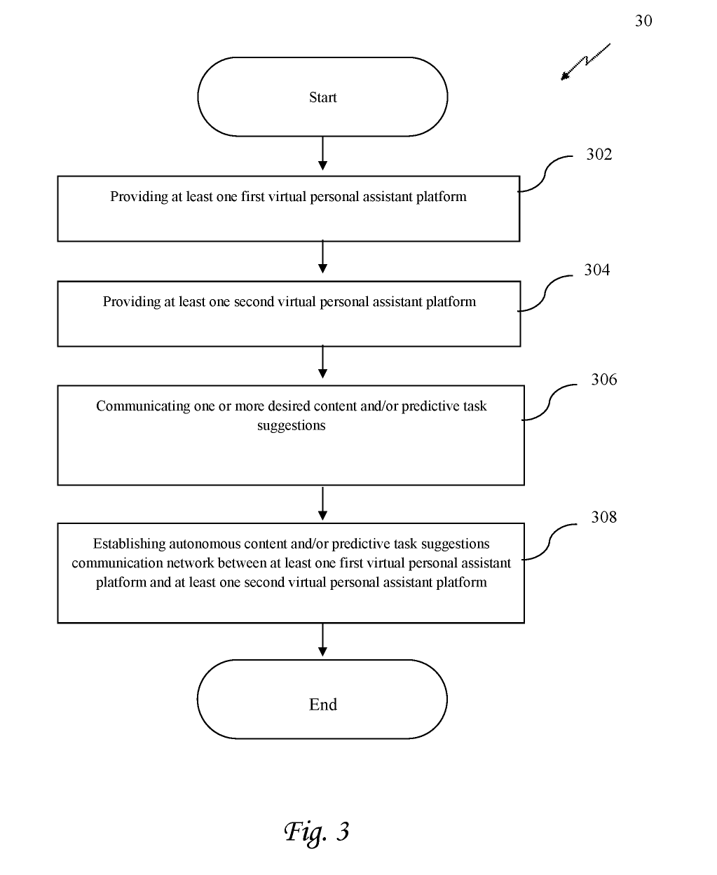

FIG. 3 presents a flow diagram method of communication network established between two more virtual personal assistant applications; and

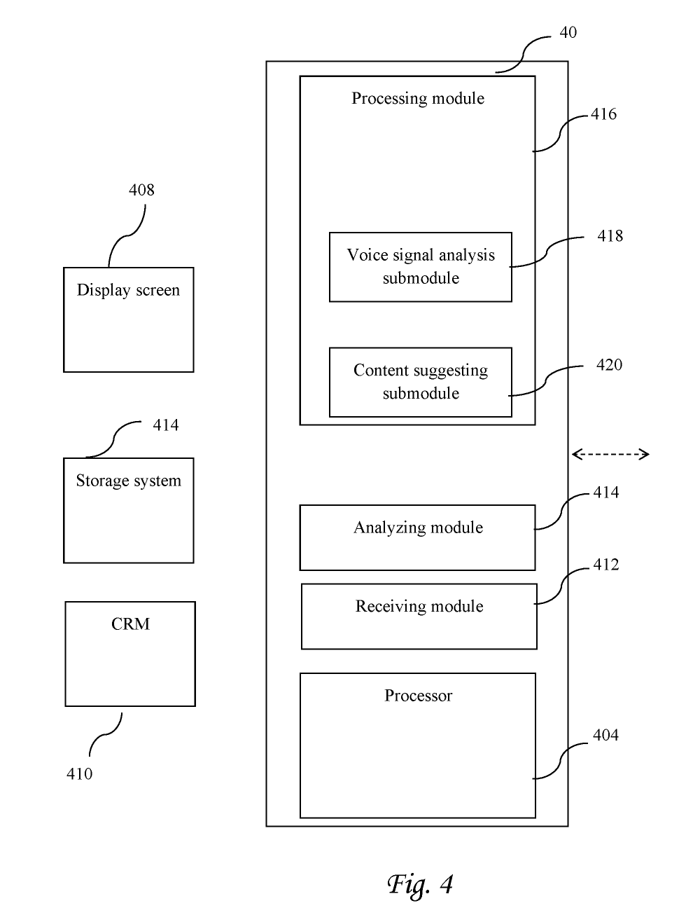

FIG. 4 presents an embodiment of the system disclosed by the present invention.

### DETAILED DESCRIPTION OF THE PREFERRED EMBODIMENTS

The publication for U.S. Pat. No. 8,078,470 B2 to Levanon, which discloses a system for indicating emotional attitudes through intonation analysis and methods thereof, is hereby incorporated in its entirety by reference into the present application.

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present description of embodiments, discussions utilizing terms such as “displaying”, “detecting,” “performing,” “identifying,” “configuring” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices, including integrated circuits down to and including chip level firmware, assembler, and hardware based micro code.

As will be explained in further detail below, the technology described herein relates to a personal virtual assistant and, more particularly, to a personal virtual assistant that receives and analyzes voice intonation data of a user, determines physiological and psychological states of the user and generates suggestions relating improving the physiological and psychological states, in particular personal virtual assistant on mobile devices.

The term “mobile/computing device” interchangeably refers, but not limited to such as a mobile phone, laptop, tablet, wearable computing device, cellular communicating device, digital camera (still and/or video), PDA, computer server, video camera, television, electronic visual dictionary, communication device, personal computer, and etc. The present invention means and methods are performed in a standalone electronic device comprising at least one screen. Additionally or alternatively, at least a portion of such as processing, memory accessible, databases, includes a cloud-based platform, and/or web-based platform. In some embodiments, the software components and/or image databases provided, are stored in a local memory module and/or stored in a remote server.

While the invention is susceptible to various modifications and alternative forms, specific embodiments thereof have been shown by way of example in the drawings and the above detailed description. It should be understood, however, that it is not intended to limit the invention to the particular forms disclosed, but on the contrary, the intention is to cover all modifications, equivalents, and alternatives falling within the spirit and scope of the invention as defined by the appended claims.

US20030182123A1 to Mitsuyoshi discloses an emotion detecting method capable of detecting emotion of a human accurately, and provide sensibility generating method capable of outputting sensibility akin to that of a human. An intensity, a tempo, and intonation in each word of a voice are detected based on an inputted voice signal, amounts of change are obtained for the detected contents, respectively, and signals expressing each states of emotion of anger, sadness, and pleasure are generated based on the amounts of change. A partner's emotion or situation information is inputted, and thus instinctive motivation information is generated. Moreover, emotion information including basic emotion parameters of pleasure, anger, and sadness is generated, which is controlled based on the individuality information.

The present invention is directed to a virtual assistant for generating personal suggestions to a user based on intonation analysis of the user. The system employs a physical analysis of tones. Linguistic analyses of syllables and words—which are dependent on the language the user is speaking and require heavy use of computational resources—are unnecessary. The reduced computer-resource requirement can allow recording and analysis over longer intervals of time—and therefore potentially greater accuracy of emotion assessment—than a linguistic-based analysis system of Mitsuyoshi.

Reference is now made to FIG. 1, which is a flow diagram of the method disclosed by the present invention 10. Said method, using a computer processing system, for generating one or more desired content and/or predictive task suggestions to a user based on voice tone analysis of the user, for a number of repetitions, comprising steps of: continuously receiving, in real-time, by a computing system comprising one or more computing devices, a voice input data 102 indicative of speech from the user; analyzing, by the computing system, said voice input data 104, based on calculating of an average and maximum intensity functions across a plurality of frequencies; determining, by the computing system, from the voice input data, based at least in part upon a change in intensity between at least two frequencies found in the calculated maximum intensity function 106, predictive intention of the user with respect to the desired content and/or tasks associated with physiological and psychological states of the user, by an executable voice signal analysis module and a runtime verification comprising a model configured to at least one domain-specific content and/or task associated with physiological and psychological states of the user, said model configured to at least one domain-specific content and/or task associated with physiological and psychological states of the user includes voice tone analysis of the user based on calculation across the plurality of frequencies by determining, at each of the plurality of frequencies, a maximum of a plurality of sample intensity values of the user speech and configured to at least one domain-specific content and/or task associated with physiological and psychological states of the user that are utilized by a executable content suggesting module, said executable content suggesting module configured to generate content on predictive intention of the user with respect to the consumed content and/or performed tasks associated with physiological and psychological states of the user during a predetermined time period; and generating, by the computing system, content suggestion 108 associated with the at least one domain-specific content and/or task associated with physiological and psychological states of the user. The content suggestion associated with the at least one domain-specific content and/or task associated with physiological and psychological states of the user includes at least one of audio content suggestion, visual content suggestion, physical good suggestion, physical exercise suggestion, mental exercise suggestion, person of contact suggestion, place of visit suggestion, food and beverage suggestion and any combination thereof.

Reference is now made to FIG. 2, which is a flow diagram method sharing one or more desired content and/or predictive task suggestions to a user based on voice tone analysis of the user between two or more users disclosed by the present invention 20. Said method, using a computer processing system, for a number of repetitions, comprising steps of: prompting, automatically, an access by at least first user to a profile of at least second user 202, said second user profile based on the content suggested for at least one domain-specific content and/or task associated with physiological and psychological states of said second user based on the second user voice input data, based at least in part upon a change in intensity between at least two frequencies found in the calculated maximum intensity function; if access granted to the at least one first user by the at least one second user, sharing said second user profile with said at least one first user 204; generating, by the computing system, content suggestion for the at least one first user associated with the at least one domain-specific content and/or task associated with physiological and psychological states of the second user to improve said physiological and psychological states of the second user 206. The content suggestion associated with the at least one domain-specific content and/or task associated with physiological and psychological states of the second user can include at least one of audio content suggestion, visual content suggestion, physical good suggestion, physical exercise suggestion, mental exercise suggestion, person of contact suggestion, place of visit suggestion, food and beverage suggestion and any combination thereof. Such content can be used by the first user to improve physiological and psychological states of the second user in a form of gift, communication, gesture or any physical affection.

Reference is now made to FIG. 3, which is a method, using a computer processing system, for establishing a network of virtual personal assistant applications communicating one with another regarding one or more desired content and/or predictive task suggestions to a user based on voice tone analysis of the user between two or more users 30, the method for a number of repetitions, comprising: providing at least one first virtual personal assistant platform 302 for sharing one or more desired content and/or predictive task suggestions to a first user based on voice tone analysis of the user embodied in one or more non-transitory computer-readable media; providing at least one second virtual personal assistant platform 304 for sharing one or more desired content and/or predictive task suggestions to a second user based on voice tone analysis of the user embodied in one or more non-transitory computer-readable media; said at least one first virtual personal assistant platform and at least one second virtual personal assistant platform are configured to communicate one or more desired content and/or predictive task suggestions 306 associated with the users based on voice tone analysis of the users between two or more users embodied in one or more non-transitory computer-readable media to each other; said at least one first virtual personal assistant platform and at least one second virtual personal assistant platform are configured to establish autonomous content and/or predictive task suggestions communication network 308.

Such network can utilize truly emotional communicational levels between different individuals regarding their true emotions and needs. On personal level, if such connection between two or more virtual personal assistant applications is established, one user can learn about true emotions and personal preferences of the other user derived from his/her true subconscious state, not affected by physiological or psychological control of his/her actions and/or emotions. Access to his/her true emotions can be utilized to improve the state of the user on a completely new level, in a form of exact content/product/action that can be directly focused on a specific state of the user.

On marketing and commercial levels, if such access is granted to user's virtual personal assistant applications by the user to different commercial parties, the targeting content can be truly personal, custom crafted and delivered based on the user's emotional or physical state at any moment, over any period of time. The benefit of such personalization is self-evident as both parties will enjoy suggestive content that is exact to the physiological or psychological state of the users, working on improving it in the most direct and updated way.

Reference is now made to FIG. 4, presenting a block diagram of one embodiment of a system of the present invention used in the step of FIG. 1-3, a virtual personal assistant platform for generating personal suggestions to a user based on intonation analysis of the user embodied in one or more non-transitory computer-readable media, said system comprising: a server 402; a mobile device 40 including a processor 404, memory 406, display 408 and computer readable media 410; a receiving module 412 communicably coupled to said processor and said server, configured to continuously receive, in real-time, by a computing system comprising one or more computing devices, a voice input data indicative of speech from the user; an analyzing module 414 configured to analyze said voice input data, based on calculating of an average and maximum intensity functions across a plurality of frequencies; a processing module 416 configured to determine from the voice input data, based at least in part upon a change in intensity between at least two frequencies found in the calculated maximum intensity function, predictive intention of the user with respect to the desired content and/or tasks associated with physiological and psychological states of the user, by an executable voice signal analysis submodule 418 and a runtime verification comprising a model configured to at least one domain-specific content and/or task associated with physiological and psychological states of the user; and generate, by the computing system, content suggestion associated with the at least one domain-specific content and/or task associated with physiological and psychological states of the user. The model is configured to at least one domain-specific content and/or task associated with physiological and psychological states of the user includes voice tone analysis of the user based on calculation across the plurality of frequencies by determining, at each of the plurality of frequencies, a maximum of a plurality of sample intensity values of the user speech and configured to at least one domain-specific content and/or task associated with physiological and psychological states of the user that are utilized by a executable content suggesting submodule 420. The executable content suggesting submodule 420 configured to generate content on predictive intention of the user with respect to the desired content and/or tasks associated with physiological and psychological states of the user in a predetermined time period and configured to generate content on predictive intention of the user with respect to the consumed content and/or performed tasks associated with physiological and psychological states of the user during a predetermined time period. The content suggestion associated with the at least one domain-specific content and/or task associated with physiological and psychological states of the user includes at least one of audio content suggestion, visual content suggestion, physical good suggestion, physical exercise suggestion, mental exercise suggestion, person of contact suggestion, place of visit suggestion, food and beverage suggestion and any combination thereof.

1. A method, using a computer processing system, for generating one or more desired content and/or predictive task suggestions to a user based on voice tone analysis of the user, the method comprising:
a. continuously receiving, in real-time, by a computing system comprising one or more computing devices, a voice input data indicative of speech from the user;
b. analyzing, by the computing system, said voice input data, based on calculating of an average and maximum intensity functions across a plurality of frequencies;
c. determining, by the computing system, from the voice input data, based at least in part upon a change in intensity between at least two frequencies found in the calculated maximum intensity function, predictive intention of the user with respect to the desired content and/or tasks associated with physiological and psychological states of the user, by an executable voice signal analysis module and a runtime verification comprising a model configured to at least one domain-specific content and/or task associated with physiological and psychological states of the user; and
d. generating, by the computing system, content suggestion associated with the at least one domain-specific content and/or task associated with physiological and psychological states of the user.

2. The method of claim 1, wherein said model configured to at least one domain-specific content and/or task associated with physiological and psychological states of the user includes voice tone analysis of the user based on calculation across the plurality of frequencies by determining, at each of the plurality of frequencies, a maximum of a plurality of sample intensity values of the user speech.

3. The method of claim 1, wherein said model configured to at least one domain-specific content and/or task associated with physiological and psychological states of the user that are utilized by an executable content suggesting module.

4. The method of claim 1, wherein said executable content suggesting module configured to generate content on predictive intention of the user with respect to the desired content and/or tasks associated with physiological and psychological states of the user in a predetermined time period.

5. The method of claim 1, wherein said executable content suggesting module configured to generate content on predictive intention of the user with respect to the consumed content and/or performed tasks associated with physiological and psychological states of the user during a predetermined time period.

6. The method of claim 1, wherein content suggestion associated with the at least one domain-specific content and/or task associated with physiological and psychological states of the user includes at least one of audio content suggestion, visual content suggestion, physical good suggestion, physical exercise suggestion, mental exercise suggestion, person of contact suggestion, place of visit suggestion, food and beverage suggestion and any combination thereof.

7. The method of claim 1, wherein determining the intention of the user includes considering feedback from the executable voice signal analysis module and/or executable content suggesting module.

8. The method of claim 1, wherein said method further comprising providing an executable voice tone analysis engine for execution on the computer processing system; and wherein receiving the voice tone input from the user includes receiving voice input from the user, and converting the voice tone input to metadata based on intensity between at least two frequencies found in the calculated maximum intensity function using the voice tone analysis engine.

9. The method of claim 1, wherein said method further comprising receiving an additional input including at least one of: a current geographical location of the user in time of voice input data analysis, touch interaction context of the user within the computing device, in-person conversation interaction context of the user using the computing device; and wherein determining the intention of the user includes considering the additional input.

10. The method of claim 1, wherein said method further comprising generating the model configured to a suggested content via a computer-assisted development tool to convert it into a graphical representation of at least one domain-specific content and/or task associated with physiological and psychological states of the user.

11. The method of claim 1, wherein said method further comprising aggregating and storing content suggested for at least one domain-specific content and/or task associated with physiological and psychological states of the user.

12. The method of claim 11, wherein said method further comprising generating a personal profile of the user based on the content suggested for at least one domain-specific content and/or task associated with physiological and psychological states of the user.

13. A method, using a computer processing system, for sharing one or more desired content and/or predictive task suggestions to a user based on voice tone analysis of the user between two or more users, the method comprising:
a. prompting, automatically, an access by at least first user to a profile of at least second user, said second user profile based on the content suggested for at least one domain-specific content and/or task associated with physiological and psychological states of said second user based on the second user voice input data, based at least in part upon a change in intensity between at least two frequencies found in the calculated maximum intensity function;
b. if access granted to the at least one first user by the at least one second user, sharing said second user profile with said at least one first user;
c. generating, by the computing system, content suggestion for the at least one first user associated with the at least one domain-specific content and/or task associated with physiological and psychological states of the second user to improve said physiological and psychological states of the second user.

14. The method of claim 13, wherein content suggestion associated with the at least one domain-specific content and/or task associated with physiological and psychological states of the second user includes at least one of audio content suggestion, visual content suggestion, physical good suggestion, physical exercise suggestion, mental exercise suggestion, person of contact suggestion, place of visit suggestion, food and beverage suggestion and any combination thereof.

15. A virtual personal assistant platform for generating personal suggestions to a user based on intonation analysis of the user embodied in one or more non-transitory computer-readable media, the virtual personal assistant platform configured to cause a computing system comprising one or more computing devices to:
a. continuously receive, in real-time, by a computing system comprising one or more computing devices, a voice input data indicative of speech from the user;
b. analyze, by the computing system, said voice input data, based on calculating of an average and maximum intensity functions across a plurality of frequencies;
c. determine, by the computing system, from the voice input data, based at least in part upon a change in intensity between at least two frequencies found in the calculated maximum intensity function, predictive intention of the user with respect to the desired content and/or tasks associated with physiological and psychological states of the user, by an executable voice signal analysis module and a runtime verification comprising a model configured to at least one domain-specific content and/or task associated with physiological and psychological states of the user; and
d. generate, by the computing system, content suggestion associated with the at least one domain-specific content and/or task associated with physiological and psychological states of the user.

16. The platform of claim 15, wherein said model configured to at least one domain-specific content and/or task associated with physiological and psychological states of the user includes voice tone analysis of the user based on calculation across the plurality of frequencies by determining, at each of the plurality of frequencies, a maximum of a plurality of sample intensity values of the user speech.

17. The platform of claim 15, wherein said model configured to at least one domain-specific content and/or task associated with physiological and psychological states of the user that are utilized by an executable content suggesting module.

18. The platform of claim 15, wherein said executable content suggesting module configured to generate content on predictive intention of the user with respect to the desired content and/or tasks associated with physiological and psychological states of the user in a predetermined time period.

19. The platform of claim 15, wherein said executable content suggesting module configured to generate content on predictive intention of the user with respect to the consumed content and/or performed tasks associated with physiological and psychological states of the user during a predetermined time period.

20. The platform of claim 15, wherein content suggestion associated with the at least one domain-specific content and/or task associated with physiological and psychological states of the user includes at least one of audio content suggestion, visual content suggestion, physical good suggestion, physical exercise suggestion, mental exercise suggestion, person of contact suggestion, place of visit suggestion, food and beverage suggestion and any combination thereof.

21. The platform of claim 15, wherein determining the intention of the user includes considering feedback from the executable voice signal analysis module and/or executable content suggesting module.

22. The platform of claim 15, further comprising providing an executable voice tone analysis engine for execution on the computer processing system; and wherein receiving the voice tone input from the user includes receiving voice input from the user, and converting the voice tone input to metadata based on intensity between at least two frequencies found in the calculated maximum intensity function using the voice tone analysis engine.

23. The platform of claim 15, further comprising receiving an additional input including at least one of: a current geographical location of the user in time of voice input data analysis, touch interaction context of the user within the computing device, in-person conversation interaction context of the user using the computing device; and wherein determining the intention of the user includes considering the additional input.

24. The platform of claim 15, further comprising generating the model configured to a suggested content via a computer-assisted development tool to convert it into a graphical representation of at least one domain-specific content and/or task associated with physiological and psychological states of the user.

25. The platform of claim 15, wherein said method further comprising aggregating and storing content suggested for at least one domain-specific content and/or task associated with physiological and psychological states of the user.

26. The platform of claim 25, wherein said method further comprising generating a personal profile of the user based on the content suggested for at least one domain-specific content and/or task associated with physiological and psychological states of the user.

27. A virtual personal assistant platform for sharing one or more desired content and/or predictive task suggestions to a user based on voice tone analysis of the user between two or more users embodied in one or more non-transitory computer-readable media, the virtual personal assistant platform configured to cause a computing system comprising one or more computing devices to:
a. prompt, automatically, an access by at least first user to a profile of at least second user, said second user profile based on the content suggested for at least one domain-specific content and/or task associated with physiological and psychological states of said second user based on the second user voice input data, based at least in part upon a change in intensity between at least two frequencies found in the calculated maximum intensity function;
b. if an access granted to the at least one first user by the at least one second user, share said second user profile with said at least one first user;
c. generate, by the computing system, content suggestion for the at least one first user associated with the at least one domain-specific content and/or task associated with physiological and psychological states of the second user to improve said physiological and psychological states of the second user.

28. The platform of claim 27, wherein content suggestion associated with the at least one domain-specific content and/or task associated with physiological and psychological states of the second user includes at least one of audio content suggestion, visual content suggestion, physical good suggestion, physical exercise suggestion, mental exercise suggestion, person of contact suggestion, place of visit suggestion, food and beverage suggestion and any combination thereof.

29. The platform of claim 27, wherein said virtual personal assistant platform of at least one first user is further configured to cause a computing system comprising one or more computing devices to autonomously continuously communicating, in real-time, with the virtual personal assistant platform of at least second user via communication means.

30. A method, using a computer processing system, for establishing a network of virtual personal assistant applications communicating one with another regarding one or more desired content and/or predictive task suggestions to a user based on voice tone analysis of the user between two or more users, the method comprising:
a. providing at least one first virtual personal assistant platform for sharing one or more desired content and/or predictive task suggestions to a first user based on voice tone analysis of the user embodied in one or more non-transitory computer-readable media;
b. providing at least one second virtual personal assistant platform for sharing one or more desired content and/or predictive task suggestions to a second user based on voice tone analysis of the user embodied in one or more non-transitory computer-readable media;
wherein said at least one first virtual personal assistant platform and at least one second virtual personal assistant platform are configured to communicate one or more desired content and/or predictive task suggestions associated with the users based on voice tone analysis of the users between two or more users embodied in one or more non-transitory computer-readable media to each other;
wherein said at least one first virtual personal assistant platform and at least one second virtual personal assistant platform are configured to establish content and/or predictive task suggestions autonomous intelligent communication network.
